(19) United States
(12) Patent Application Publication
(10) Pub. No.: US 2022/0044567 A1
(43) Pub. Date: Feb. 10, 2022

(54) SYSTEM AND METHOD FOR IMPROVING OPERATIONAL SAFETY OF A ROADWAY CONSTRUCTION SITE

(71) Applicant: Zachary Paul Liollio, Charleston, SC (US)

(72) Inventor: Zachary Paul Liollio, Charleston, SC (US)

(21) Appl. No.: 16/988,768

(22) Filed: Aug. 10, 2020

(51) Int. Cl. G08G 1/16; G08G 1/00; G08G 1/0967

(52) U.S. Cl. CPC G08G 1/162; G08G 1/096775; G08G 1/22

(57) ABSTRACT

Disclosed are various embodiments for roadway construction management and safety. Roadway construction is inherently filled with danger and obstacles which require an orchestrated set of management policies and safety procedures. The disclosed embodiments improve roadway construction management as well as roadway construction safety through use of autonomous vehicular control and positioning systems. Further, the improvements allow remote control and overall access to roadway safety vehicles in the roadway construction zones in which potential hazards may occur. The use of such embodiments reduces the human capital requirement as well as reduces the risk of casualty and loss of life for both the roadway construction workers and roadway travelers traversing roadway construction zones.

### FIELD

The present invention relates generally to a comprehensive system and method of providing operational safety at a construction site through a connected system of on-board mobile computers and detailed mapping and transmission of time-sensitive control instructions along with automated discovery of parameters through technologies such as computer vision, self-adapting actuators and attenuators, and roadway construction vehicle control systems and sensors.

### BACKGROUND

Unless otherwise indicated herein, the materials described in this section are not prior art to the claims in this application and are not admitted as prior art by inclusion in this section.

Construction site safety alongside highways, freeways, and local roads continues to be a present threat for crews. These work zones are occupied by a complex array of signs, barrels, and lane changes that present risks for the motorist as well as the workers who build, repair, and maintain the streets, bridges, and highways. It is reported by the United States Center for Disease Control and Prevention that from 1982 through 2017, a total of 27,037 individuals lost their lives in roadway construction work zone crashes. The United States Bureau of Labor Statistics reports that from 2003-2017 over 1,844 roadway construction workers lost their lives within roadway construction zones. Transportation events accounted for 76 percent of roadway work zone occupational injuries from 2011-2017, and in 60 percent of those cases the worker was struck by a vehicle in the work zone.

Vehicle attenuators and truck mounted attenuators by companies such as TrafFix™ https://www.traffixdevices.com and J-Tech™ https://jtechusa. com are common examples of roadway safety vehicles that are purpose-built to increase the safety of roadway construction workers as well as roadway travelers that traverse roadway construction zones. These companies have focused on increasing operator safety and safety of others through primarily hardware elements such as the attenuators visible on the organizations' websites. However, these companies lack offerings that advance the usage of computational power to help secure roadway environments, reduce manpower, and increase safety.

Modern advancements in roadway construction equipment have improved the safety of the workers as well as occupants in construction vehicles and those who traverse the roadway work zone. However, there is a long felt need to improve the safety in work zones by reducing operator requirements and lowering the risk of occupants in vehicles alongside roadway construction by utilizing the power of computer vision, and remote and autonomous vehicle control.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic diagram that illustrates a side view of a representative embodiment of a plurality of roadway construction vehicles and operative equipment.

FIG. 2 is a schematic diagram that illustrates a top-down view of a representative embodiment of a plurality of roadway construction vehicles and operative equipment.

FIG. 3 is a schematic diagram of an example embodiment of a crash attenuator vehicle.

FIG. 4 is an exploded view of an example embodiment of a site management vehicle.

FIG. 5 is a pictorial diagram of an example embodiment of an input device equipped on the site management vehicle.

FIG. 6 is a block diagram of an example embodiment of a mobile computing device.

FIG. 7 is a flow chart of an example embodiment of the method for roadway construction management and safety.

FIG. 8 is a flowchart of an example embodiment of the method for roadway construction management and safety.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

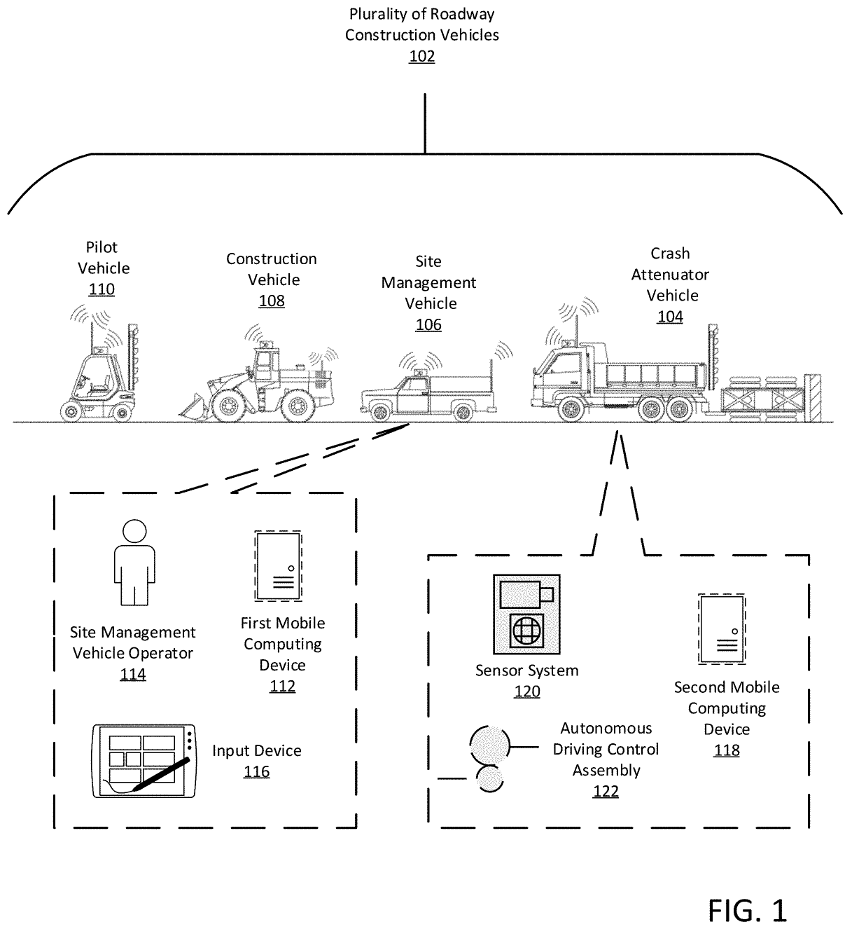

Referring now to FIG. 1, a schematic diagram that discloses an example embodiment of a side view of a plurality of roadway construction vehicles (102) and operative equipment. The plurality of roadway construction vehicles (102) is not limited to vehicles depicted in FIG. 1, and additional example embodiments include typical roadway construction vehicles such as articulated trucks, asphalt pavers, compressors, backhoe loaders, cold planers, compact track and multiterrain loaders, crushers, dozers, feller bunchers, forest machines, remixing transfer vehicles, skidders, skid steer loaders, screeners, road wideners, track excavators, wheel dozers, wheel excavators, wheel loaders, wheel tractor scrapers, dump trucks, and hauling vehicles. Roadway construction vehicles are essential aspects of roadway construction projects and due to the industrial nature of the vehicles present, add additional risks of harm to roadway construction workers as well as roadway travelers that are near the roadway construction zone. In the example embodiment of the plurality of roadway construction vehicles (102), all of the vehicles are equipped with a communications assembly, a mobile computing device, input devices (116), sensor systems (120), and autonomous driving control assemblies (122).

The crash attenuator vehicle or truck mounted attenuator (104), these terms are used synonymously in this disclosure, is an important element to any roadway construction project as it is the barrier of safety to the roadway construction workers, the roadway construction project, and the vehicles traversing the roadway. Roadway construction equipment visibility and recognition is imperative to safe and effective roadway construction projects. The disclosed embodiments are an improvement on and seek to address the risk associated with working and traversing in and around roadway construction zones.

In the example embodiment of FIG. 1, the crash attenuator vehicle (104) is at the rear of the roadway construction project and contains a crash attenuator and a arrow message board to alert oncoming traffic of the roadway construction project. The crash attenuator vehicle (104) is equipped with a communications assembly that allows communication to the site management vehicle (106), as well as the entire plurality of roadway construction vehicles (102). The crash attenuator vehicle (104) is equipped with autonomous driving technology and is often found as a pickup truck or larger truck capable of towing a truck-mounted attenuator. J-Tech™ is an example equipment manufacturer for truck-mounted crash attenuators which can be found at the following hyperlink https://jtechusa.com/metro-scorpion-attenuator-trucks. Additional attenuators such as attenuator trucks are included in the disclosure, and examples thereof can also be seen on the J-Tech™ web site at the following hyperlink https://jtechusa.com/attenuator-trucks.

Standard features of a crash attenuator vehicle or a truck mounted crash attenuator (104) include a an energy absorbing region, a hinge to allow for retraction of the energy absorbing region when in storage or not in operation, heavy-duty steel bulkheads, manpods for conveying and deployment of road cones, high visibility red stakesides, non-skid deck coating, ballast, hydraulic arrow board, backup camera system, and an advanced lighting package. In the example embodiment the crash attenuator vehicle (104) includes a mobile computing device. The mobile computing device is coupled to the crash attenuator vehicle (104) so that the mobile computing device is integrated into the crash attenuator vehicle's power supply. Additional embodiments allow the mobile computing device to be plug-and-play and capable of switching from any one of the plurality of roadway construction vehicles (102). In the example embodiment the crash attenuator vehicle (104) is a truck-mounted crash attenuator, in additional disclosure the crash attenuator vehicle (104) is a vehicle with the crash attenuator integrated within.

In the example embodiment the sensor system (120) contains an image processing unit that includes two cameras located at the front of the vehicle and two cameras at the rear of the vehicle which record a stereo image of the environment. The spatial image photographed by the four cameras is converted through an inverse transformation in an image processing unit on the mobile computing system into a plane image. For example, the image processing unit identifies yellow guidelines painted along the travel path, a travel path side boundary, a center line and the like, and measures the length of the lines in relation to the vehicle. In particular, through the sensing of the yellow guidelines on the travel path, the spatial relationship between the vehicle and the travel path is calculated, i.e. the distance of the vehicle from the yellow guideline on the left or right side of the travel path, the angle between the forward direction of the vehicle and the travel path, and the like and, in the case of a curved travel path, the direction of the curve is determined at half the distance of the travel path.

In the example embodiment the sensor system (120) further contains an ultrasonic sensor, a laser radar, and receivers for detecting obstacles located on the travel path in front of the vehicle and to the side of the vehicle, as, for example, a vehicle traveling in front, a protective barrier, and the like, and for transmitting the corresponding information to the mobile computing device of the vehicle. Additional sensors in the sensor system (120) of the present embodiment include wheel speed sensors that are located on the left and right rear wheels of the vehicle, a mobile computing device, in the example of FIG. 1, the second mobile computing device (118) is equipped with a processing unit that receives and processes the output signals of the two wheel speed sensors, and a global positioning unit for calculating the location of the vehicle in global coordinates. The processing unit and the calculation unit are executed in the mobile computing device onboard the crash attenuator vehicle and the site management vehicle. The wheel speed sensors detect the rotation of the crash attenuator vehicle's rear wheels and generate several thousand pulses per revolution for each wheel. When a difference is found in the number of pulses generated for the individual wheels, this means that there is a difference in the distance covered by the corresponding wheels, and this difference in the distance covered forms the basis for determining the curvature of the section of travel path being traveled by the vehicle. In addition, the distance covered by both wheels indicates the distance traveled by the crash attenuator vehicle. The path of the crash attenuator vehicle (104) can thus be calculated on the basis of the sequences of data provided by the wheel speed sensors and transmitted to the site management vehicle (106) wherein the site management vehicle operator (114) controls the parameters in which the crash attenuator vehicle (104) may operate under. In particular, information relating to the location and position of the vehicle at a specific point in time, i.e. information regarding the vehicle's location and direction of travel in an X-Y coordinate system, can be derived and transmitted to the site management vehicle (106).

The crash attenuator vehicle (104) is equipped to sense and determine the safe distance between the next construction vehicle of the plurality of construction vehicles (102) to prevent additional roadway damage. The crash attenuator vehicle calculates the distance by the following factors: the weight of the crash attenuator, the friction coefficient of a brake-engaged crash attenuator, the speed limit on the roadway, the distance traveled if impacted by an average vehicle, and a safe distance of travel post-impact to prevent contact with the next construction vehicle of the plurality of construction vehicles (102). In the present embodiment the formula employed is Total Force=((((M₁×A₁)(M₂×A₂)−S_{pow})×Friction Coefficient). Total force then defines the stoppage distance required and the distance metric is employed based upon the factors such as temperature, roadway material, surface conditions, and the kind to determine an adequate following distance.

The autonomous driving control assembly (122) of FIG. 1 is the equipment, both hardware and software, needed to perform autonomous driving capabilities such as safe follow and full level 3 and higher levels of automation. In particular level 3 automation requires the crash attenuator vehicle (104) to perform all aspects of the driving task under some circumstances. In those circumstances, the human driver, or in our case the site management vehicle operator, can remotely take back control through the input device and the first mobile computing device, when the autonomous driving system request the operator to do so. In level 4 the system itself performs all driving tasks and monitors the driving environment, not requiring the operator to pay attention. Lastly, in level 5, the crash attenuator vehicle can do all of the driving in all circumstances. In our example embodiment the defined circumstances are within a work zone and priority is given to allow safe follow distance from the remaining plurality of roadway construction vehicles, so that in the event of an impact to the crash attenuator vehicle, the remaining plurality of roadway construction vehicles and workers remain unaffected.

In the example embodiment of FIG. 1 the autonomous driving control assembly (122) is equipped with an electronic control unit ‘ECU’ that is either coupled with or integrated within the second mobile computing device (118). The second mobile computing device (118) is a general-purpose mobile computing device equipped with the hardware and software to control and configure the sensor system (120) and the autonomous driving control assembly (122), as well as interface with software to provide frequent updates to the interface and control systems. The autonomous driving control assembly (122) is configured to actuators, gears, computing systems and the like and the technology for allowing a vehicle such as a truck to be equipped with the various hardware and software elements is well known. Advancements in the present embodiment include sensor systems within the truck mounted attenuator such as a 360 degree camera system, in what could be considered a trailer apparatus, and the use of LIDAR and other computer vision sensors such as radar and 3D dot projection. Further advancements to the autonomous driving control assembly (122) include integration with the wiring harness of a roadway construction vehicle and synchronous usage with the onboard computing systems.

Automated computing machinery, as that phrase is used in this disclosure and as it is utilized in the first mobile computing device (112) and the second mobile computing device (118), means a module, segment, or portion of code or other automated computing logic, hardware, software, firmware, and other logic, as well as the combination of any of the aforementioned, as will occur to those of skill in the art—both local and remote. Automated computing machinery is often implemented as executable instructions, physical units, or other computing logic for implementing the specified logical function(s) as will occur to those of skill in the art. As mentioned, such automated computing machinery implement logical units both local and remote and as such, often implement data communications across buses, networks, wired and wireless as will occur to those of skill in the art and all such data communications are well within the scope of the present invention.

The communications assembly equipped in the plurality of roadway construction vehicles (102) of FIG. 1 is often implemented through cellular standards such as 1G™, 2G™, 3G™, 4G LTE™ and 5G™ and is directly interfaced to the mobile computing devices. Additional communication protocols such as Bluetooth™, wireless LAN, wireless WAN, and SAN are also capable of transmission of data such as vehicle positioning and vehicle status through the network. Transmitting the crash attenuator vehicle (104) status and positioning to the site management vehicle (106) and ultimately to the first mobile computing device (112), where the site management vehicle operator (114) controls aspects of the system through the input device (116) is capable of occurring over the several data communication protocols such as a cellular data transmission, WI-FI transmission, transmission using Bluetooth™, and other network protocols as will occur to those of skill in the art in networking administration.

The site management vehicle (106) of FIG. 1 includes being operated by a site management vehicle operator (114), a first mobile computing device (112) and an input device (116). The site management vehicle operator (114) utilizes the input device which can be a touch display capable of displaying the plurality of roadway vehicles (102) and the operator thus has the capability of initiating certain aspects of the vehicles such as engaging the autonomous following capabilities and the autonomous driving capabilities. The operator is also presented with a selection of configuring parameters such as the safe follow distance for the crash attenuator vehicle (104) or to default to the formulaic following distance disclosed herein. The input device (116) being configured to the site management vehicle (106) allows an overall display that is coupled to the first mobile computing device (112) wherein the devices are linked over the communications assembly to the plurality of roadway vehicles (102) as well as a central server. The central server can serve as a broker between the plurality of roadway vehicles (102) and the home office of the roadway construction management team. Importantly, the input device (116) receives input from the site management vehicle operator (114) and is capable of transmitting the input to the crash attenuator vehicle (104), where it is received by the second mobile computing device (118) and is configured to work with the processing units equipped thereon, including the processing units for the sensor system (120) and the autonomous driving control assembly (122).

The pilot vehicle (110), also known as an escort vehicle, is responsible for communicating to motorists, signaling intentions of the roadway construction project as it moves along a stretch, reporting and inspecting as the project moves, and review routes, traffic control plans, communication equipment and emergency procedures. Many of these responsibilities can be shared with other vehicles such as a site management vehicle (106). The pilot vehicle (110) is directly responsible for navigation, communication, height pole operation, and providing adequate warning to motorists. The pilot vehicle (110) must also monitor and evaluate hazards in real time and communicate about hazards in enough time for the roadway construction vehicles to successfully negotiate the hazard.

Stopping distances for the pilot vehicle (110) along with safe driving practices vary from condition of the roadway to the weather and current equipment on the construction vehicles. Formulaically, the pilot vehicle should recognize the stopping distances increase by the square of the amount the speed is increased. Therefore, if speed doubles from 20 mph to 40 mph, the distance needed to stop increases by a magnitude of 4 times. Roadway construction vehicles often weigh as much as 20-30 times that of passenger vehicles, and the stopping distances are increased by that weight. This formula is also employed in the other autonomous vehicles such as the crash attenuator vehicle (104). It is imperative that the pilot vehicle (110) be in constant communication with the plurality of roadway construction vehicles (102) to ensure safe operation in the work zone and to move the work zone and project along the set parameters.

The construction vehicle (108) is any construction vehicle and forms part of the workflow process. Typical construction vehicles were discussed previously, and they are incorporated herein. The construction vehicle (108) may also incorporate the autonomous driving technology present in the crash attenuator including a mobile computing device, a sensor system, and an autonomous driving control assembly. The construction vehicles are often designed for specific tasks such as loading, spraying asphalt binder, grading and leveling, or other special purposes like spraying weed remover or painting roadway markings. Many of these special purpose tasks have metrics associated with them such as amount of material deposited. The present disclosure includes the onboard sensor system capable of measuring weight metrics and other metrics associated with depositing or removing material so as to report to the coordinating server or to the site management vehicle (106) the metrics.

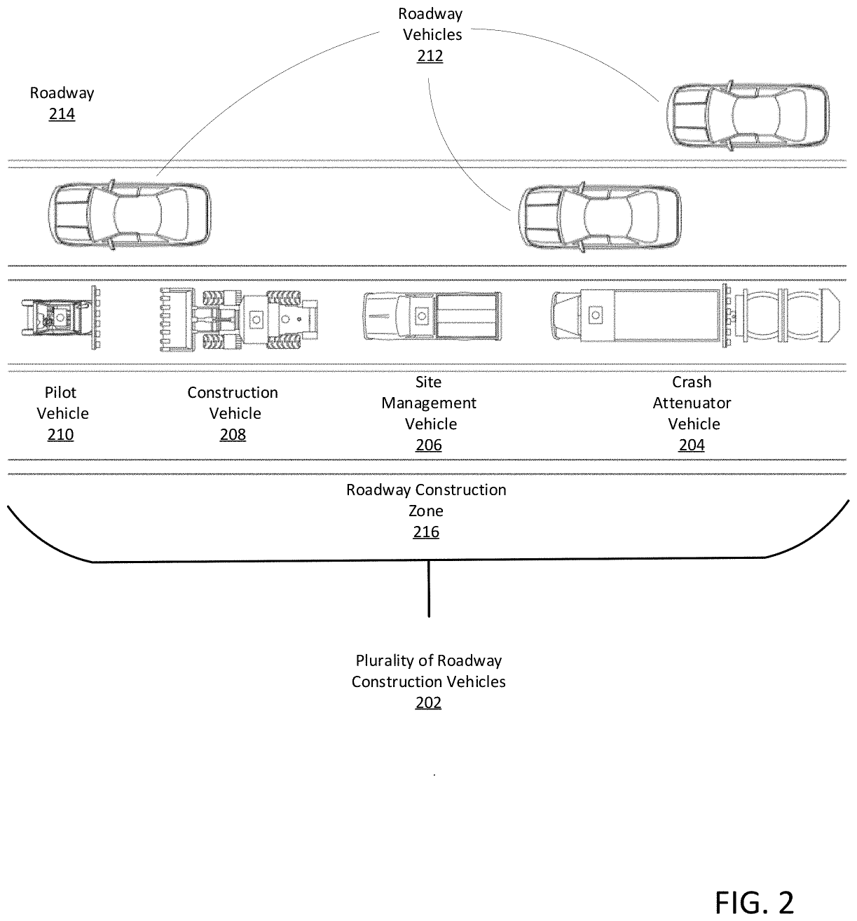

FIG. 2 is a schematic diagram that illustrates a top down view of a representative embodiment of a plurality of roadway construction vehicles (202) and operative equipment. The plurality of roadway construction vehicles (202) are positioned in a roadway construction zone (216), where roadway construction work occurs. These zones often stretch for multiple miles and begin well in advance and end well after where the actual construction work is being completed. The work zone is an area of activity in which large vehicles, workers, and civilian vehicles all culminate in an environment that presents additional risk and danger. The pilot vehicle (210) is in the front of the plurality of roadway construction vehicles (202) and sets the pace for the roadway construction project, including bearing a sign board to identify itself from the remaining vehicles. The construction vehicle (208) is a general construction vehicle, in additional embodiments the construction vehicle can be any of the other listed vehicles disclosed herein. The construction vehicle (208) is equipped with onboard sensor system that allows for autonomous driving, but also includes sensors for measuring items such as deposited material weight, speed, efficiency, and other parameters associated with placing materials onto roadway construction zones. The site management vehicle (206) leads and orchestrates operation at the site level and is in charge of providing direction to the plurality of roadway construction vehicles (202). The crash attenuator vehicle (204) is positioned at the terminal end of the roadway construction zone (216) and follows the plurality of roadway construction vehicles (202) as the project advances. The crash attenuator vehicle (204) is equipped with autonomous driving technology which reduces the required manpower, but more importantly removes the human life from one of the most dangerous positions—the vehicle that first meets oncoming traffic. The roadway (214) can be any type of roadway of any surface material, those familiar with roadway construction will immediately be able to identify the various kinds of roadways and the specific requirements for travel on each. The roadway vehicles (212) are cars, trucks, and other vehicles that are certified and licensed to drive on roadways.

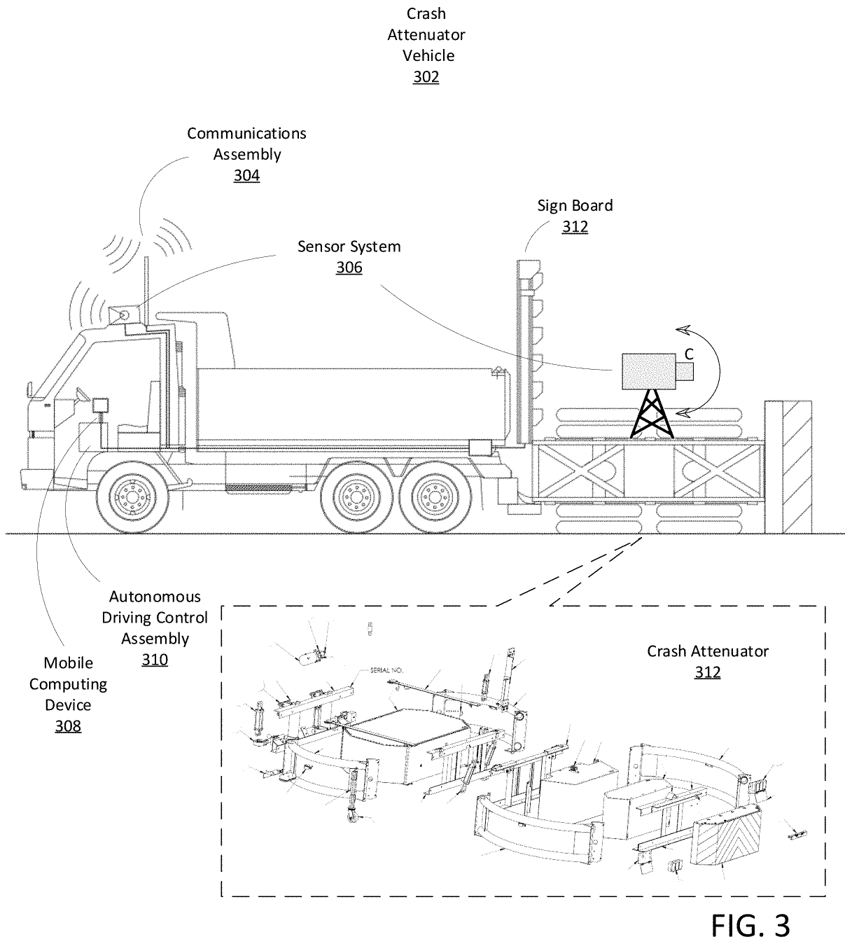

FIG. 3 is a schematic diagram of an example embodiment of a crash attenuator vehicle (302). In FIG. 3 the crash attenuator vehicle is a truck mounted crash attenuator vehicle. Both the truck mounted crash attenuator and crash attenuator vehicle are of the same in this disclosure and can be used interchangeably. The crash attenuator vehicle (302) is equipped with a communications assembly (304). The communications assembly maintains the communications array in which it transmits and receives signals from the site management vehicle and the coordinating server. Additional embodiments include the communications assembly (304) transmitting and receiving from the plurality of roadway construction vehicles as well as passenger vehicles equipped to receive communications. For example, the communications assembly (304) can be equipped to broadcast in FM and AM radio waves so that passenger vehicles traversing the work zone can receive information such as average travel speed, expected time to traverse work zone, precautions, and general information of the roadway project and any information that may be necessary such as emergency information or supervisory information.

In the example embodiment of FIG. 3, the crash attenuator (302) is disclosed as a breakdown of the various elements. For our purposes the actual crash attenuating device is not of concern, it is expected to perform by reducing impact and mitigating casualty in the event of an impact. The crash attenuator vehicle (302) is equipped with standard autonomous driving technology and specialty autonomous driving technology components that are unique to the roadway construction project. Such components include the sensor system mounted on the truck mounted crash attenuator which moves the sensing element from the main chassis and applies it to the trailer mount to increase visualization over the sign board (312) and adjusts the sensing environment for the rapidly oncoming traffic. The unique positioning of the multiple sensor system allows this special application for the special purpose task of providing roadway safety in an autonomous fashion to remove the roadway worker from a site of high risk of casualty and replace the operational aspect with an autonomous driving capability and management of the system from the site management vehicle. The sensor system (306) includes radar, LIDAR, and a 360-degree camera system. In alternative embodiments just a camera system is used, and likewise in other embodiments just LIDAR or radar is employed, the parts may be combined together or utilized separately to perform the task of level 3 autonomous driving or higher. The autonomous driving control assembly (310) controls the vehicular operation of the crash attenuator vehicle (302), such as the steering, acceleration, breaking, warning lights, turn signals, throttle, idle speed, and other functions that are required to autonomously move a vehicle.

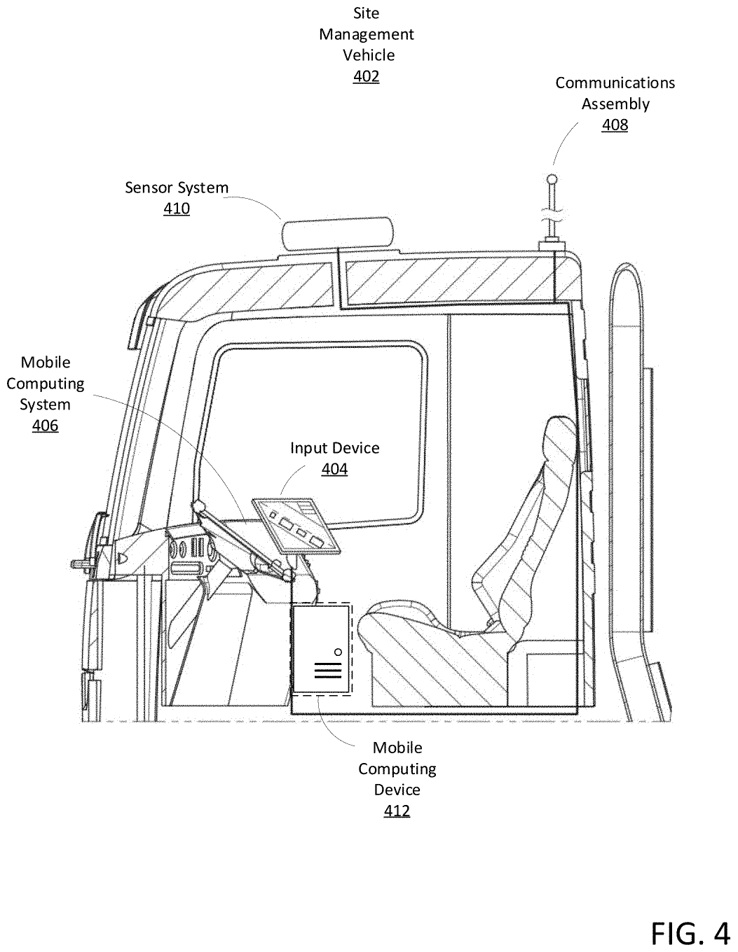

Referring now to FIG. 4, an exploded view of an example embodiment of a site management vehicle (402). The site management vehicle (402) in the example embodiment of FIG. 4 is a standard pickup truck fitted with the specialized equipment discussed herein. Additional embodiments of a site management vehicle include a special purpose built roadway construction vehicle that is built to control the functionality of the plurality of roadway construction vehicles. It is contemplated that future roadway construction vehicles will be imparted with significantly more intelligence and computing power as to give the vehicle a special purpose, such special purpose is contemplated and disclosed herein. The site management vehicle (402) is equipped with a sensor system (410), including a radar, LIDAR, 360-degree camera system, and the like to enable itself to be fully autonomous driving capable. In the example embodiment a site management vehicle operator is able to ride in the cab of the truck and utilize the input device (404) to control the workflow, organization, and safety of the plurality of roadway construction vehicles, including engaging, disengaging, pausing, and manually controlling the autonomous driving functionality on the plurality of roadway construction vehicles. The mobile computing system (406) is equipped to receive input from the sensor system as well as direct and amplify communications through the communications assembly (408). The communications assembly includes the standard cellular protocols listed herein as well as wireless and other technologies of moving data and information wirelessly. The site management vehicle (402) is equipped with standard pickup features and the mobile computing system (406) is developed to integrate within the onboard computer and in additional embodiments replaces the onboard computer for functionality of the vehicle.

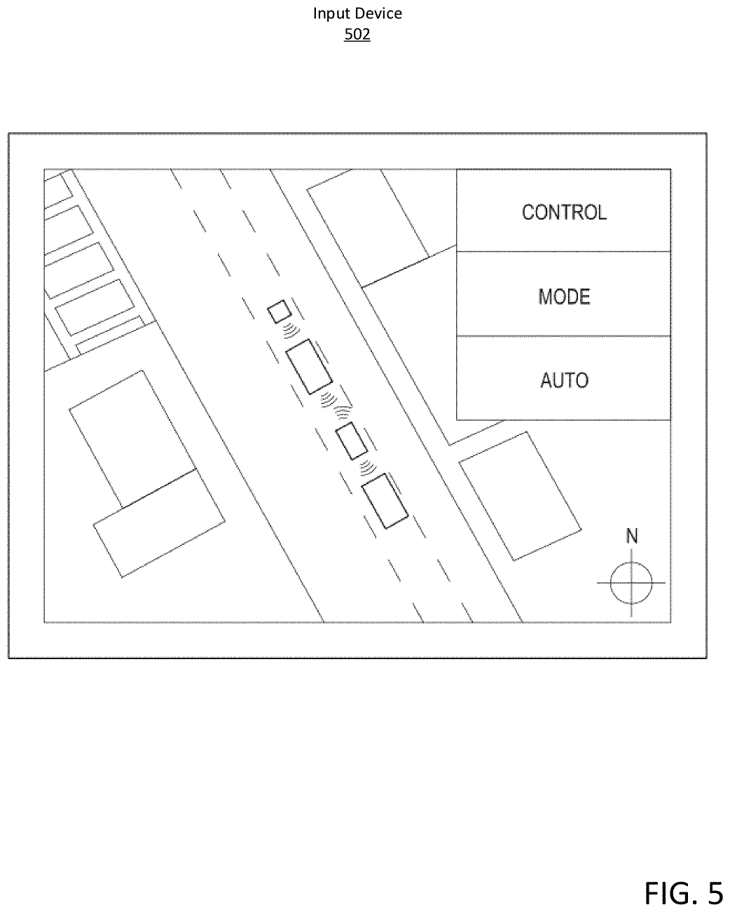

FIG. 5 provides an example embodiment of an input device (502). The input device (502) is a tablet style device that is capable of receiving input and displaying options to a site management vehicle operator. The display of the input device (502) can be one in which it is a straightforward display that serves as an I/0 function to the mobile computing device, or it can have computing power such as that found on a tablet computer. The input device (502) is equipped to receive a signal and display in a user interface of the application for managing a roadway construction project, including an overview of the plurality of roadway construction vehicles and options to select autonomous driving mode. The input device also is capable of receiving input through both touch and through a device such as a keyboard, a mouse, or voice command. As advancements in processing power improve it is contemplated that the input device will house the mobile computing device and serve as the controlling mobile computing device in operation of the plurality of the roadway construction vehicles. In view on the input device (502) the selection of auto mode is displayed that engages autonomous following on the crash attenuator vehicle. The control function allows the site management vehicle operator to take over manual control of the crash attenuator as well as set parameters such as following distance, speed, relative following limits and alter functionality such as the sign board message and the pattern of blinking warning lights and sounds. The input device (502) serves as a main control input for the roadway construction project and has further functionality such as receiving and displaying material usage metrics, including tar, gravel, stone, and other depository materials, the rate of deposit, and the volume remaining.

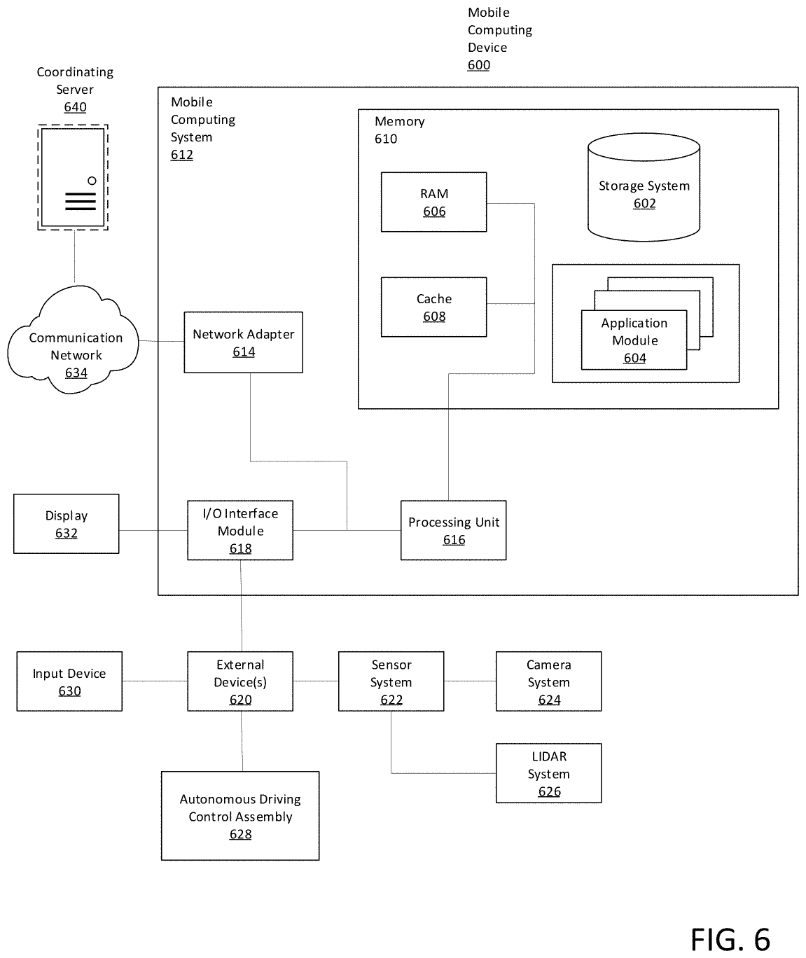

In the example embodiment of FIG. 6, the mobile computing device (612), is a general-purpose computing system that is equipped on the plurality of roadway construction vehicles, such as the site management vehicle and the crash attenuator vehicle. The mobile computing device (612) is comprised of several components that are both unique to general computing and include specialized I/O functionality. The mobile computing device (612) contains a storage system (602) that is comprised of solid-state drive technology or may also be equipped with other hard drive technologies for storage of computing information. The autonomous driving modules and software applications reside in long term memory on the storage system (602). The memory (610) component of the mobile computing device (612) also contains Random Access Memory ‘RAM’ (606) which holds the program instructions along with a cache (608) for buffering the flow of instruction to the processing unit (616). Often times the executed application module (604) will reside in RAM (606) as instructions are executed by the processing unit (616). A sample of these instruction include the processing unit from the sensor system (622) and the autonomous driving control assembly (628). These processing units can be stand-alone mobile computing devices or integrated within to the main mobile computing device. The present embodiment is disclosed as a fully integrated system, however it is disclosed that separate mobile computing devices for each system may be connected via the I/O interface and through the communication network (634) to perform the tasks of sensing the environment and adjusting the course path through the autonomous driving control assembly (628).

In the example embodiments of FIG. 6, the processing unit (616) travels through a bus to the network adapter (614) that facilitates communications via network cards, wireless, Bluetooth™, and local area network adapters. The processing unit (616) is further configured through a bus to the input output interface module I/O (618), the I/O module is connected to the display (622), or in the site management vehicle the input device, which displays the GUI of the roadway construction application. The I/O module (618) is further configured to interface with many other external devices (620) such as universal serial bus adapters, lightning ports, power ports, sensor systems (622), including camera systems (624) and LIDAR systems (626), along with radar systems, and autonomous driving control assemblies (628), and a whole host of additional I/O devices that are traditionally found interfacing with a general-purpose and or special purpose computing devices. The Coordinating server (640) is connected to the communication network (634) and is a stand-alone computing device in which a plurality of mobile computing devices can connect with to share information or through an application protocol. FIG. 6 is but one example embodiment of the configured mobile computing device (600) additional configurations and components of a general-purpose and special purpose computing devices are disclosed herein.

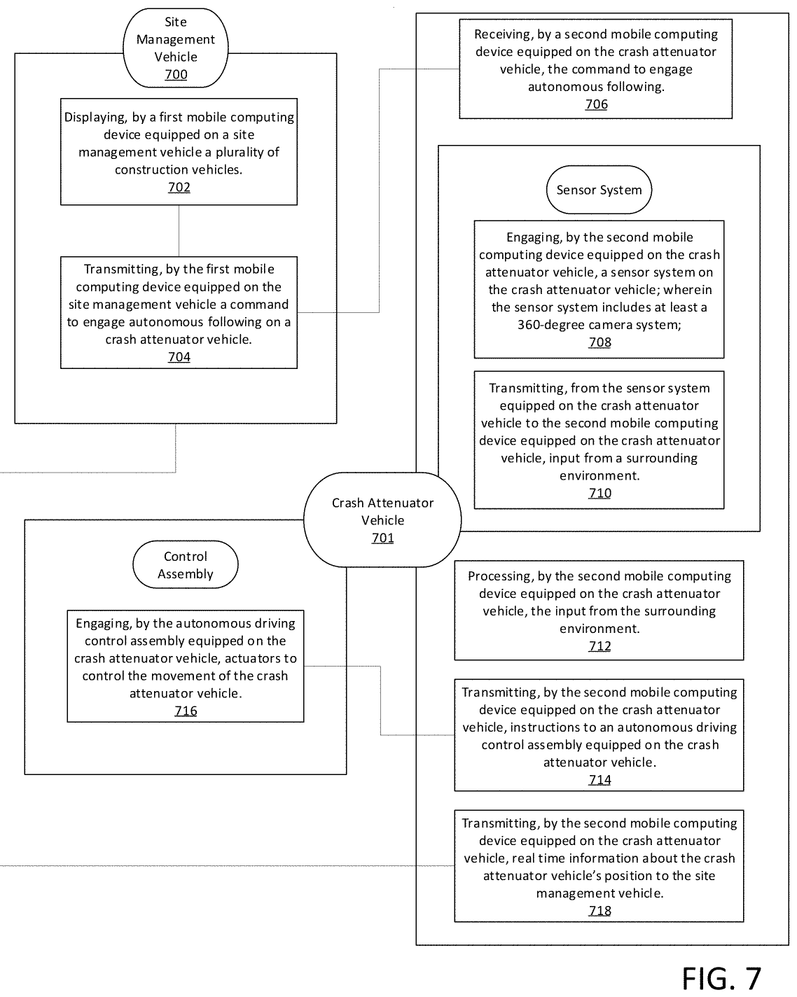

Referring now to FIG. 7, a flow chart of the disclosed example embodiment of the method for roadway construction management and safety. In FIG. 7 the site management vehicle (700) and the crash attenuator vehicle (701) are displayed as example embodiments. In further embodiments, the pilot vehicle takes the place of the crash attenuator vehicle, and in further embodiments all of the plurality of roadway construction vehicles are equipped with the same features as the crash attenuator vehicle.

In FIG. 7, the example embodiment begins with displaying to the site management vehicle operator the current status of the onboard system and vehicles present at the roadway construction project. Additional information such as time, weather conditions, and system uptime and availability of autonomous vehicle enablement is also present. The site management vehicle operator then enters a command on the input device which transmits a signal and instructions to the crash attenuator vehicle to engage autonomous following of the plurality of roadway construction vehicles. Autonomous following can be manually specified by a set of parameters entered by the site management vehicle operator or may be derived by the onboard algorithm discussed earlier. The crash attenuator vehicle receives the signal and instructions from the site management vehicle (706) and by receiving the onboard mobile computing device initiates the sensory system and the autonomous driving control assembly. The onboard mobile computing device is equipped to enable level 3-5 autonomous driving capability with the intent and purpose of reducing manpower and increasing safety by removing the operator from the crash attenuator vehicle, the vehicle in which the highest degree of risk of accident and harm is attributed to. Following receiving the signal and transmission the crash attenuator engages the sensor system, wherein that sensor system includes at least a 360-degree camera system to monitor the surroundings of the crash attenuator vehicle as well as enable following of the plurality of roadway construction vehicles. Additional sensors include a LIDAR sensor, a radar sensor, and dot projection sensors for finite movement and accuracy in moving a crash attenuator vehicle through a danger-laden roadway construction zone. When engaged, the crash attenuator vehicle transmits signals and information received by the sensor system (710) concerning the immediate environment to the mobile computing device equipped on the crash attenuator vehicle. This mobile computing device processes (712) the input from the sensor system of the surrounding environment and transmits (714) to the autonomous driving control assembly instructions to maneuver the crash attenuator vehicle. The control assembly on the crash attenuator vehicle is usually paired with the mobile computing device but may also be a separate stand-alone mobile computing device in which it interacts in unison with the mobile computing device of the crash attenuator vehicle. Upon receiving signals and information from the sensory system through the mobile computing device the control assembly engages the autonomous driving control assembly (716) onboard the crash attenuator vehicle. By engaging, the control assembly activates the actuators and motors along with accompanying hardware and software required to mobilize the crash attenuator vehicle for autonomous driving. When autonomous driving mode is engaged the crash attenuator transmits from the onboard mobile computing device to the site management vehicle up to date and real-time crash attenuator vehicle positioning and placement in the roadway construction zone (718). The update also includes operational safety information including whether or not the crash attenuator vehicle has been impacted and has built in functionality to signal to emergency crews that an impact has occurred.

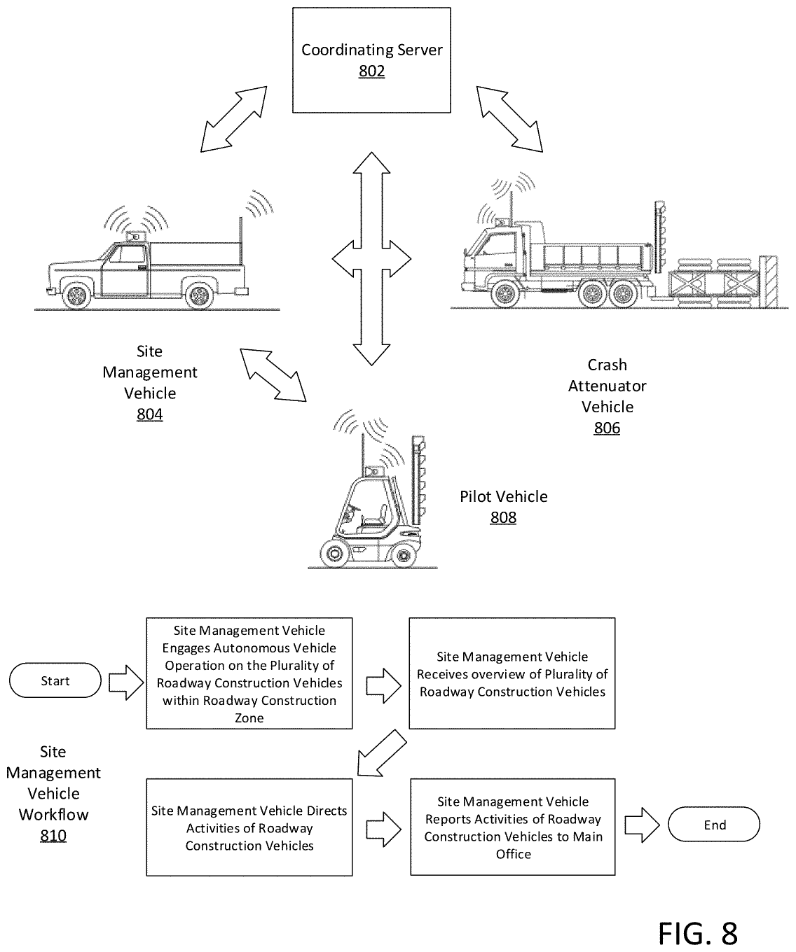

Referring now to FIG. 8, the coordinating server (802) is a server that sits above the entire plurality of roadway construction vehicles and is a cloud-based server in which all of the roadway construction vehicles transmit positioning information and status of the vehicle. In doing so the coordinating server (802) maintains information regarding the entire roadway construction zone and is able to process and transmit that information in real time to the plurality of roadway construction vehicles and to any other enabled and access granted computing device. Additional benefits of a coordinating server (802) such as synchronization through a common software platform, portability, centralized processing power, security, as well as a host of benefits that are typical with a cloud computing environment. The site management vehicle (804) transmits and receives signals and information from the plurality and can replace the coordinating server for remote sites that lack cellular communications. The site management vehicle (804) includes a site management operator in which manual input into an input device can be entered to control operations and safety at a local level of the roadway construction zone. The crash attenuator vehicle (806) is equipped with a crash attenuator and receives information through the coordinating server, including the signal and information to engage autonomous driving and or autonomous following mode. The crash attenuator vehicle (806) is at the terminal end of the plurality of construction vehicles with a purpose of signaling to oncoming traffic that a work zone is immediate and to provide an impact barrier, an attenuator, that absorbs the energy from an impact with the goal of reducing harm. The crash attenuator vehicle (806) maintains an onboard mobile computing system that interacts with a sensor system and an autonomous driving control assembly to enable autonomous driving. The pilot vehicle (808) sits at the opposite terminal end of the plurality of construction vehicles and it is responsible for planning and direction as well as safety. In the given disclosure the pilot vehicle (808) is equipped with the same capabilities as the crash attenuator vehicle (806) including the capability to drive autonomously, and the equipment discussed herein to enable the same operation as the crash attenuator vehicle (806). The pilot vehicle (808) also includes a sign board to indicate to traffic the end of the roadway work zone. Pilot vehicles play a key role in also controlling the speed of the plurality of roadway construction vehicles and the goal of the pilot vehicle (808) is to provide a clear path, overcoming obstacles such as reduced height bridges and navigating additional encumbrances so that the roadway construction project can flow in a productive fashion.

Continuing, in FIG. 8, an example embodiment of a workflow for the site management vehicle (810) is disclosed. The site management vehicle engages autonomous vehicle operation on the plurality of roadway construction vehicles, the onboard mobile computing devices on the plurality of roadway construction vehicles receives the signal and engages autonomous driving mode. The site management vehicle, through the operator, maintains control and can direct the individual roadway construction vehicles including taking over control from autonomous driving mode. Additionally, the site management vehicle serves as the nerve center and reports back through the coordinating server events occurring at the roadway construction project.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A system for roadway construction safety management, comprising:
a plurality of roadway construction vehicles, the plurality of roadway construction vehicles having at least one crash attenuator vehicle and at least one site management vehicle;
a first mobile computing device, wherein the first mobile computing device is equipped to the at least one site management vehicle;
a second mobile computing device, wherein the second mobile computing device is equipped to the at least one crash attenuator vehicle;
a sensor system, wherein the sensor system is configured to the at least one crash attenuator vehicle, and further wherein the sensor system is configured to the second mobile computing device of the at least one crash attenuator vehicle;
an autonomous driving control assembly, wherein the autonomous driving control assembly is configured to the at least one crash attenuator vehicle, and wherein the autonomous driving control assembly is configured to the second mobile computing device of the at least one crash attenuator vehicle; and
an input device, wherein the input device is configured to the at least one site management vehicle, wherein the input device is configured to receive input and communicate the input to the first mobile computing device on the at least one site management vehicle.

2. The system of claim 1, wherein the at least one crash attenuator vehicle is equipped with LIDAR.

3. The system of claim 1, wherein the at least one crash attenuator vehicle is equipped with radar.

4. The system of claim 1, wherein the at least one crash attenuator vehicle is equipped with fire suppressant material.

5. The system of claim 1, wherein the at least one crash attenuator vehicle is equipped with an emergency call feature, the emergency call feature is configured to alert emergency responders when the at least one crash attenuator vehicle is involved in a collision.

6. The system of claim 1, wherein further comprising a pilot vehicle, wherein the pilot vehicle is equipped with a mobile computing device, and wherein the pilot vehicle is equipped with a sensor system, and wherein the pilot vehicle is equipped with an autonomous driving control assembly.

7. The system of claim 1, wherein the at least one site management vehicle equipped with the first mobile computing device, and equipped with the input device, is further equipped with a communications assembly to communicate to a remote office server, wherein communicating to a remote office server transmits details of a roadway construction zone and the plurality of roadway construction vehicles.

8. A method for roadway construction management and safety, comprising:
displaying, by a first mobile computing device equipped on a site management vehicle, an overview of a plurality of construction vehicles located at a roadway construction site;
transmitting, by the first mobile computing device equipped on the site management vehicle, a command to engage autonomous following on a crash attenuator vehicle;
receiving, by a second mobile computing device equipped on the crash attenuator vehicle, the command to engage autonomous following;
engaging, by the second mobile computing device equipped on the crash attenuator vehicle, a sensor system on the crash attenuator vehicle, wherein the sensor system includes at least a 360-degree camera system;
transmitting, from the sensor system equipped on the crash attenuator vehicle to the second mobile computing device equipped on the crash attenuator vehicle, input from a surrounding environment;
processing, by the second mobile computing device equipped on the crash attenuator vehicle, the input from the surrounding environment;
transmitting, by the second mobile computing device equipped on the crash attenuator vehicle, instructions to an autonomous driving control assembly equipped on the crash attenuator vehicle;
engaging, by the autonomous driving control assembly equipped on the crash attenuator vehicle, wherein engaging activates actuators to control the movement of the crash attenuator vehicle;
transmitting, by the second mobile computing device equipped on the crash attenuator vehicle, confirmation of activation of the autonomous driving control assembly to the first mobile computing device equipped on the site management vehicle;
transmitting, by the second mobile computing device equipped on the crash attenuator vehicle, wherein transmitting communicates real time information about the crash attenuator vehicle.

9. The method of claim 8, further comprising receiving, from the site management vehicle, a notification when the crash attenuator vehicle has received an impact.

10. The method of claim 8, further comprising calculating, by the second mobile computing device equipped on the crash attenuator vehicle, the safe distance between the next construction vehicle of the plurality of construction vehicles to prevent additional roadway damage, wherein calculating includes determining the speed limit on the roadway, the distance traveled if impacted by a roadway vehicle, the friction coefficient for the roadway surface, and a safe distance of travel post impact to prevent contact with the next construction vehicle of the plurality of construction vehicles.
